(19) United States
(12) Patent Application Publication
(10) Pub. No.: US 2012/0226000 A1
(43) Pub. Date: Sep. 6, 2012

(54) POLYVINYL CHLORIDE CONTAINING MULTIARMED STAR COPOLYMERS

(75) Inventors: Virgil Percec, Philadelphia, PA (US); Paul O. Hong, Hainesport, NJ (US)

(73) Assignees: Tekni-Plex ,Inc., Somerville, NJ (US); The Trustees of the University of Pennsylvania, Philadelphia, PA (US)

(21) Appl. No.: 13/132,433

(22) PCT Filed: Dec. 4, 2009
(86) PCT No.: PCT/US2009/066693

§ 371 Date: Apr. 18, 2012

Related U.S. Application Data
(60) Provisional application No. 61/120,085, filed on Dec. 5, 2008.

(51) Int. Cl. C08G 63/91; C08G 63/682

(52) U.S. Cl. 525/419; 528/220

(57) ABSTRACT

The invention concerns processes for the production of multiarmed star copolymers comprising polymerizing vinyl chloride with a multifunctional initiator in the presence of Na₂S₂O₄ and water. The invention also concerns polymers made from the processes and articles made from the polymers.

### RELATED APPLICATIONS

This application claims benefit of U.S. Patent Application No. 61/120,085, filed Dec. 5, 2008, the disclosure of which is incorporated by reference herein in its entirety.

### STATEMENT OF GOVERNMENT SUPPORT

This invention was made using government support from National Science Foundation Grants DMR-0548559 and DMR-0520020. Accordingly, the United States Government may have certain rights in the invention described herein.

### TECHNICAL FIELD

The present invention concerns multiarmed star copolymers containing polyvinyl chloride moieties.

### BACKGROUND

The industrial scale synthesis of PVC involves conventional free-radical polymerization. This polymerization method is accompanied by secondary inter- and intramolecular chain transfer reactions, which lead to the formation of PVC with structural defects, such as tertiary chlorine, internal and terminal chloroallylic groups, and other irregularities such as chloromethyl and chloroethyl branches. See, Starnes, et al., J Polym Sci Part A: Polym Chem 2005, 43, 2451-2467; Asandei and Percec, J Polym Sci Part A: Polym Chem 2001, 39, 3392-3418; and Purmova, et al., Macromolecules 2005, 38, 6352-6366. The presence of these structural defects reduces the thermal stability of PVC and limits its technological applications.

Living polymerizations provide access to polymers of predetermined molecular weight, functional chain ends and narrow molecular weight distribution. Various approaches to living radical polymerization (LRP) have been elaborated for the synthesis of functional polymers with linear and more complex topologies. See, Otsu, Polym Sci Part A: Polym Chem 2000, 38, 2121-2136; Solomon, J Polym Sci Part A: Polym Chem 2005, 43, 5748-5764; Hawker, et al., Chem Rev 2001, 101, 3661-3688; Perrier and Takolpuckdee, Polym Sci Part A: Polym Chem. 2005, 43, 5347-5393; Barner-Kowollik and Perrier, J Polym Sci Part A: Polym Chem. 2008, 46, 5715-5723; Yamago, J Polym Sci Part A: Polym Chem 2006, 44, 1-12; Kamigaito and Satoh, J Polym Sci Part A: Polym Chem 2006, 44, 6147-6158; Kamigaito, et al, M. Chem Rev 2001, 101, 3689-3746; Braunecker and Matyjaszewski, Prog Polym Sci 2007, 32, 93-146; Percec, et al. J Am Chem Soc 2003, 125, 6503-6516; Percec, et al., J Polym Sci Part A: Polym Chem 2004, 42, 505-513; and Percec, et al., J Polym Sci Part A: Polym Chem 2005, 43, 4894-4906. Until several years ago LRP methods were available only for activated monomers such as acrylates, methacrylates, acrylonitrile, styrene, etc. It was considered that VC would not be accessible by any living polymerization mechanism including LRP. See, Stockland, and Jordan, J Am Chem Soc 2000, 122, 6315-6316; Stockland, et al., J Am Chem Soc 2003, 125, 796-809; Foley, et al., J Am Chem Soc 2003, 125, 4350-4361; Queffelec, et al., Macromolecules, 2000, 33, 8629-8639. Recently, our laboratory discovered two closely related LRP methods which are compatible with vinyl chloride, namely Single Electron Transfer-Degenerative Chain Transfer Living Radical Polymerization (SET-DTLRP) and Single Electron Transfer-Living Radical Polymerization (SET-LRP). See, Percec, et al., J Am Chem Soc 2002, 124, 4940-4941; Percec, et al., J Polym Sci Part A: Polym Chem 2003, 41, 3283-3299; Percec, et al., J Polym Sci Part A: Polym Chem 2004, 42, 6267-6282; Percec, et al., J Polym Sci Part A: Polym Chem 2004, 42, 6364-6374; Percec, et al., J Polym Sci Part A: Polym Chem 2005, 43, 287-295; Percec, et al., J Polym Sci Part A: Polym Chem 2005, 43, 773-778; Percec, et al., J Polym Sci Part A: Polym Chem 2005, 43, 779-788; Percec, et al., J Polym Sci Part A: Polym Chem 2005, 43, 2185-2187; Percec, et al., J Polym Sci Part A: Polym Chem 2005, 43, 2276-2280; Coelho, et al., J Polym Sci Part A: Polym Chem 2006, 44, 3001-3008; Coelho, J et al., Mat Sci Forum 2006, 514-516, 975-979; Coelho, et al., Eur Polym J2006, 42, 2313-2319; Coelho, et al., J Vinyl Addit Technol 2006, 12, 156-165; Coelho, et al., J Appl Polym Sci 2008, 109, 2729-2736; Percec, et al., PCT Int Appl 2002 WO 0277043; Percec, et al., J Polym Sci Part A: Polym Chem 2005, 43, 1478-1486; Percec, et al., J Polym Sci Part A: Polym Chem 2005, 43, 1649-1659; Percec, et al., J Polym Sci Part A: Polym Chem 2005, 43, 1660-1669; Percec, et al., J Polym Sci Part A: Polym 29 Chem 2005, 43, 1948-1954; Coelho, et al., J Polym Sci Part A: Polym Chem 2006, 44, 2809-2825; Coelho, et al., Macromol Chem Phys 2007, 208, 1218-1227; Coelho, et al., J Polym Sci Part A: Polym Chem 2008, 46, 421-432; Coelho, J et al., J Polym Sci Part A: Polym Chem 2008, 46, 6542-6551; Percec, et al., J Am Chem Soc 2006, 128, 14156-14165; Guliashvili, T.; Percec, Polym Sci Part A: Polym Chem 2007, 45, 1607-1618; Monteiro, et al., J Polym Sci Part A: Polym Chem 2007, 45, 1835-1847; Lligadas and Percec, J Polym Sci Part A: Polym Chem 2007, 45, 4684-4695; Rosen, J Polym Sci Part A: Polym Chem 2007, 45, 4950-4964; Lligadas, et al., J Polym Sci Part A: Polym Chem 2008, 46, 278-288; Lligadas and Percec, J Polym Sci Part A: Polym Chem 2008, 46, 2745-2754; Lligadas and Percec, J Polym Sci Part A: Polym Chem 2008, 46, 3174-3181; Lligadas and Percec, V. J Polym Sci Part A: Polym Chem 2008, 46, 4917-4926; Lligadas and Percec, J Polym Sci Part A: Polym Chem 2008, 46, 6880-6895; and Rosen and Percec, J Polym Sci Part A: Polym Chem 2008, 46, 5663-5697.

SET-DTLRP is initiated with iodoform or other iodo-containing initiators including methylene iodide and catalyzed by Cu(0), Cu₂O, Cu₂S, Cu₂Se, Cu₂Te, CuCl, CuI in the presence of a ligand and solvent that mediates the disproportionation of Cu(I)X by Na₂S₂O₄ and (NH₂)₂C═SO₂ in water at ambient temperature. S₂O₄²⁻ dissociates in organic phase (VC) into the radical anion SO²⁻•which acts as an electron-donor that mediates the activation step of dormant propagating species via a SET mechanism. Both SET-LRP and SET-DTLRP processes proceed via a single-electron transfer (SET) mechanism at least in the activation step. When VC is polymerized with Na₂S₂O₄, degenerative transfer (DT) is the dominant pathway for reversible deactivation.

### SUMMARY

In some aspects, the invention concerns processes for the production of multiarmed star copolymers comprising polymerizing vinyl chloride with a multifunctional initiator in the presence of Na₂S₂O₄ and water. Certain multifunctional initiator are bifunctional or tetrafunctional initiators. In certain embodiments, the multifunctional initiators are iodo terminated. Certain of these initiators contain 2 or 4 terminal groups of formula I or formula II:

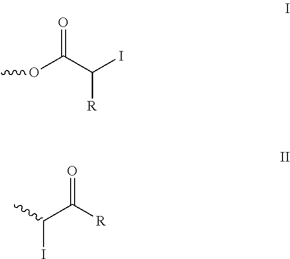

where R is a C₁-C₄ alkyl group or a C₁-C₄ alkoxy group. In some embodiments, R is methyl. Preferred multifunctional initiators include 1,2-bis(iodopropionyloxy)ethane, dimethyl 2,5-diiodohexanedioate, bis(2-methoxyethyl)-2,5-diiodohexanedioate, pentaerythritol tetrakis(2-iodopropionate), or [PBA-CH(CH₃)—COO—CH₂]₄C where PBA is iodo terminated poly(n-butyl acrylate).

In certain embodiments, the terminal groups of formula I or II are attached to an alkyl, aryl, arylalkyl or alkylaryl core group.

In some embodiments, the molar ratio of Na₂S₂O₄ to multifunctional initiator is 2:1 to 100:1. In certain embodiments, the molar ratio of vinyl chloride to multifunctional initiator is 500 to 10,000. Some contacting/reacting steps are performed at a temperature of 20 to 60° C. In certain embodiments, the molar ratio of Na₂S₂O₄ to multifunctional initiator is 2:1 to 100:1, the molar ratio of vinyl chloride to multifunctional initiator is 500 to 10,000, and the contacting is performed at a temperature of 20 to 60° C.

Some polymer produced by the instant processes have each arm of the multiarmed star copolymer has a molecular weight (Mₙ) of 200 to 35,000.

In some embodiments, a chain of poly(n-butyl acrylate) can be attached at the iodo-substituted position of formula I or II. An iodo terminated poly(n-butyl acrylate) chain can be added, for example, via SET-DTLRP of n-butyl acrylate via techniques described herein.

In certain processes, the multiarmed star copolymer comprises [PVC-b-PBA-CH(CH₃)—COO—CH₂]₄C where PVC is polyvinyl chloride and PBA is poly(n-butyl acrylate). In this construction, PVC is attached to the PBA section of the arm at the terminal end of the arm.

The invention also concerns the intermediate compound [PBA-CH(CH₃)—COO—CH₂]₄C where PBA is iodo terminated poly(n-butyl acrylate).

The invention also concerns articles made from the compounds described herein. Certain preferred articles are substantially free of plasticizer. By substantially free of plasticizer is meant that the article contains less than 5% or 1% or 0.1% by weight of plasticizer. In some embodiments, the articles is substantially free of phthalates. As used herein “phthalates” means esters of phthalic acid. Some esters are C₁-C₁₅ esters. Other esters are C₄-C₁₅.

The invention also concerns multiarmed star copolymers comprising polyvinyl chloride polymer described herein. In another aspect the invention concerns processes for making an article comprising polyvinyl chloride comprising forming said article from a multiarmed star copolymer comprising polyvinyl chloride made by the process described herein, the performing occurring substantially in the absence of a plasticizer.

### BRIEF DESCRIPTION OF THE DRAWINGS

FIG. 1 presents kinetic plots of the Na₂S₂O₄/NaHCO₃ mediated SET-DTLRP of VC initiated with 1,2-bis(iodopropionyloxy)ethane-BIPE bifunctional initiator. Conditions: VC=2.2 g, H₂O=9 mL, surfactants: 4.99% Celvol 540=293 mg, 4.20% Methocel K100=110 mg, [VC]₀=3.20 mol/L, and [VC]₀/[BIPE]₀=350, (a and b): T=25° C.; (c and d): T=35° C.; (e and f): T=45° C.

FIG. 2 presents kinetic plots of the Na₂S₂O₄/NaHCO₃ mediated SET-DTLRP of VC initiated with 1,2-bis(iodopropionyloxy)ethane-BIPE bifunctional initiator. Conditions: VC=2.2 g, H₂O=9 mL, surfactants: 4.99% Celvol 540=293 mg, 4.20% Methocel K100=110 mg, [VC]₀=3.20 mol/L, and [VC]₀/[BIPE]₀=1400, (a and b): T=25° C.; (c and d): T=45° C.

FIG. 3 presents kinetic plots of the Na₂S₂O₄/NaHCO₃ mediated SET-DTLRP of VC initiated with dimethyl 2,5-diiodohexanedioate (DMDIH) bifunctional initiator (a and b) and bis(2-methoxyethyl) 2,5-diiodohexanedioate (BMEDIH) bifunctional initiator (c and d). Conditions: VC=2.2 g, H₂O=9 mL, surfactants: 4.99% Celvol 540=293 mg, 4.20% Methocel K100=110 mg, [VC]₀=3.20 mol/L, [VC]₀/[DMDIH]₀=350 and [VC]₀/[BMEDIH]₀=350, T=25° C.

FIG. 4 presents HSQC spectrum in CD₂Cl₂ of PVC with Mₙ^{GPC}=9,385, M_{w}/Mₙ=2.00 obtained at 21% conversion in SET-DTLRP of VC initiated with BIPE. Polymerization conditions: [VC]₀/[BIPE]₀/[Na₂S₂O₄]₀/[NaHCO₃]₀=350/1/2/2.2.

FIG. 5 presents 500 MHz ¹H NMR selected spectra of PVC. The samples was obtained by the Na₂S₂O₄/NaHCO₃ catalyzed LRP of VC in H₂O initiated with 1,2-bis(iodopropionyloxy)ethane-BIPE bifunctional model initiator at 25° C. Polymerization conditions were as follows: [VC]₀/[BIPE]₀/[Na₂S₂O₄]0/[NaHCO₃]₀=350/1/1/2/2.2, H₂O=9 mL, 4.99% Celvol 540=293 mg, Methocel K100=110 mg, VC=2.2 g, [VC]₀=3.2 mol/L.

FIG. 6 presents 500 MHz ¹H NMR selected spectra of PVC. The samples were obtained by the Na₂S₂O₄/NaHCO₃ catalyzed SET-DTLRP of VC in H₂O initiated with dimethyl 2,5-diiodohexanedioate (DMDIH) bifunctional initiator at 25° C. Polymerization conditions were as follows: [VC]₀/[DMDIH]₀/[Na₂S₂O₄]₀/[NaHCO₃]₀/[p-TsNa]₀=350/1/4/2/2, H₂O=9 mL, 4.99% Celvol 540=293 mg, 4.20% Methocel K100=110 mg, VC=2.2 g, [VC]₀=3.2 mol/L.

FIG. 7 presents 500 MHz ¹H NMR selected spectra of PVC. The samples were obtained by the Na₂S₂O₄/NaHCO₃ catalyzed LRP of VC in H2O initiated with bis(2-methoxyethyl) 2,5-diiodohexanedioate-BMEDIH bifunctional model initiator at 25° C. Polymerization conditions were as follows: [VC]₀/[BMEDIH]₀/[Na₂S₂O₄]₀/[NaHCO₃]₀=350/1/2/2.2, H₂O=9 mL, 4.99% Celvol 540=293 mg, 4.20% Methocel K100=110 mg, VC=2.2 g, [VC]₀=3.2 mol/L.

FIG. 8 concerns SET-DTLRP of VC initiated with iodo terminated tetrafunctional initiator (4IPr). Reaction conditions: [VC]₀/[4IPr]₀/[Na₂S₂O₄]₀/[NaHCO₃]₀/[p-TsNa]₀=500/1/16/4/4 at 25° C. (a) and [VC]₀/[4IPr]₀/[Na₂S₂O₄]₀/[NaHCO₃]₀=500/1/32/8 at 25° C. (b), VC=2.2 g, H₂O=9 mL, 4.99% Celvol 540=290 mg, 4.20% Methocel K100=110 mg.

FIG. 9 concerns SET-DTLRP of VC catalyzed by Na₂S₂O₄/NaHCO₃ and initiated with pentaerythritol tetrakis(2-iodopropionate) (4IPr) star initiator at 25° C. Polymerization conditions were as follows: [VC]₀/[4IPr]₀/[Na₂S₂O₄]₀/[NaHCO₃]₀/[p-TsNa]₀=350/1/8/4/4, H₂O=9 mL, 4.99% Celvol 540=273 mg, 4.20% Methocel=110 mg, VC=2.2 g, [VC]₀=3.2 mol/L; a)-b) kinetic plots, c) structure of star PVC, d)-f) 500 MHz ¹H NMR spectra of selected PVC samples. *Mₙ NMR was calculated based on —CH₃ and —CHCl— integral.

FIG. 10 presents kinetic plots of the Na₂S₂O₄ catalyzed SET-DTLRP of VC initiated with the four-arm star PBA-4IPr tetrafunctional macroinitiator with Mₙ=14,864, M_{w}/Mₙ=1.642. Reaction conditions: VC=2.2 g, H₂O=9 mL, surfactants: 4.99% Celvol 540=15.4 mg, 4.20% Methocel K100=4.4 mg, [VC]₀=3.20 mol/L, and [VC]₀/[PBA-4IPr]₀=1000, T=35° C.

FIG. 11 presents kinetic plots of the Na₂S₂O₄ catalyzed SET-DTLRP of VC initiated with the four-arm star PBA-4IPr tetrafunctional macroinitiator with Mₙ=14,864, M_{w}/Mₙ=1.642. Reaction conditions: VC=2.2 g, H₂O=9 mL, surfactants: 4.99% Celvol 540=15.4 mg, 4.20% Methocel K100=4.4 mg, [VC]₀=3.20 mol/L, and [VC]₀/[PBA-4IPr]₀=5000, T=25° C.

FIG. 12 presents 500 MHz ¹H NMR selected spectra of (a) four-arm star PBA macroinitiator (Mₙ=14,864, M_{w}/Mₙ=1.642). The macroinitiator was obtained by the Na₂S₂O₄/NaHCO₃ catalyzed LRP of BA in H₂O initiated with 4IPr tetrafunctional initiator at 25° C. Polymerization conditions were: [BA]₀/[4IPr]₀/[Na₂S₂O₄]₀/[NaHCO₃]₀/[p-TsNa]₀=100/1/4/2/2, H₂O=18 mL, 4.99% in H₂O Celvol 540=29 mg, Methocel K100=11 mg, BA=6.4 g, [VC]₀=1.98 mol/L. (b) and (c) four-arm star PBA-PVC block copolymers obtained by the Na₂S₂O₄ catalyzed LRP of VC in H₂O initiated with the four-arm star PBA tetrafunctional macroinitiator at 35° C. Polymerization conditions were: [VC]₀/[PBA-4IPr]₀/[Na₂S₂O₄]₀/[NaHCO₃]₀/[p-TsNa]₀=1000/1/8/4/4, H₂O=9 mL, 4.99% Celvol 540=293 mg, 4.20% Methocel K100=110 mg, VC=2.2 g, [VC]₀=3.2 mol/L.

### DETAILED DESCRIPTION OF ILLUSTRATIVE EMBODIMENTS

In one aspect, the invention concerns Na₂S₂O₄ catalyzed Single-Electron Transfer-Degenerative Chain Transfer mediated Living Radical Polymerization (SET-DTLRP) of vinyl chloride (VC) initiated with multifunctional initiators such as bifunctional initiators 1,2-bis(iodopropionyloxy)ethane, dimethyl 2,5-diiodohexanedioate, and bis(2-methoxyethyl)-2,5-diiodohexanedioate as well as the tetrafunctional initiator pentaerythritol tetrakis(2-iodopropionate). This SET-DTLRP can be performed in water at ambient temperature in the presence of polyvinyl alcohol and hydroxypropyl methylcellulose surfactants. The invention provides methods for the synthesis of α,ω-di(iodo)PVC with two identical active chain ends and of the four-arm star PVC with four identical active chain ends. These difunctional and tetrafunctional derivatives of PVC are also macroinitiators for the synthesis of ABA triblock copolymers and four-arm star block copolymers.

In some embodiments, the synthesis by SET-DTLRP is catalyzed by Na₂S₂O₄ in water in the presence of Celvol 540 and Methocel K100 of perfectly bifunctional and four-arm star tetrafunctional iodo-terminated PVC. The synthesis of bifunctional and tetrafunctional initiators employed in this process is also detailed herein.

The present invention also teaches use of a tetrafunctional initiator for the synthesis of the first example of four-arm star-block copolymer containing PVC and poly(n-butyl acrylate) (PBA) segments. This novel PVC based topology [PVC-b-PBA-CH(CH₃)—CO—O—CH₂]₄C was accessed by the SET-DTLRP catalyzed by Na₂S₂O₄ in water at ambient temperature initiated from a tetrafunctional initiator.

The PVC containing star block copolymer produced herein have industrial potential over flexible and structural PVCs currently based on 1) improved or new properties, 2) lower cost, and/or 3) reduction in the use of toxic or environmentally problematic plasticizers currently added to achieve flexibility. Currently these flexible PVCs may contain as much as 60% by weight of plasticizers.

One class of toxic plasticizer that has received attention is the phthalates. The Washington [State] Toxics Coalition reports that phthalates can be found in PVC wallpaper, flooring, shower curtains, raincoats, packaging, medical equipment and tubing, and toys. Phthalates are not chemically bound to PVC and therefore can leach out of products over time, and can be found in air inside buildings and in dust. Phthalates have been found in groundwater, surface water, and sediment. Phthalate syndrome can potentially lead to abnormal development of the male reproductive system because they are endocrine disruptors that either mimic or block the action of human hormones. The Washington Toxics Coalition has been particularly concerned with children's toys where up to 47% phthalates were found in common toys such as rubber ducks. Phthalates in toys and children's products have been banned by the European Union, but are allowed in most of the US except for California. A PVC block copolymer achieving flexibility without toxic plasticizers, has potential to revolutionize the manufacturing process.

Another potential advantage to the instant technology is PVC could be used in thermoplastic elastomers (TPEs) with a potential to reduce raw material costs. Most polymer costs directly relate to the cost of petroleum; however, because PVC is half composed of inexpensive chloride reacted from salt, only half of its raw material cost tracks with petroleum.

Potential applications of the star polymers disclosed herein include resin compounds; lubricants; colloidal stabilizers; binders; and pressure sensitive adhesives. The star structure, as opposed to a linear structure, has the ability to modify rheology, viscosity, and durability of copolymers formed. Biocompatible star copolymers also have potential as micelles for drug delivery.

As used herein, the term “alkyl”, whether used alone or as part of another group, refers to a substituted or unsubstituted aliphatic hydrocarbon chain and includes, but is not limited to, straight and branched chains containing from 1 to 12 carbon atoms. Examples of alkyl groups include methyl, ethyl, propyl, isopropyl, butyl, i-butyl and t-butyl. Specifically included within the definition of “alkyl” are those aliphatic hydrocarbon chains that are optionally substituted.

The term “aryl”, as used herein, means an optionally substituted aromatic 5- to 13-membered mono- or bi-carbocyclic ring such as phenyl, naphthyl, or biphenyl. Preferably, groups containing aryl moieties are monocyclic having 5 to 7 carbon atoms in the ring. Phenyl is one preferred aryl.

The term “arylalkyl”, as used herein, refers to the group —R^{c}-R^{d}, where R^{c} is an alkyl group as defined above, substituted by R^{d} aryl group(s), as defined above.

The term “alkylaryl”, as used herein, refers to the group —R^{e}-R^{f}, where R^{e} is an aryl group as defined above, substituted by R^{f} alkyl group(s), as defined above.

The carbon number as used in the definitions herein refers to carbon backbone and carbon branching, but does not include carbon atoms of the substituents.

Optional substituents on the aforementioned groups include, for example, nitro, cyano, —N(R^{a})(R^{b}), halo, hydroxy, carboxy, alkyl, alkenyl, alkynyl, cycloalkyl, aryl, heteroaryl, alkoxy, aryloxy, heteroaryloxy, alkylalkoxy, alkoxycarbonyl, alkoxyalkoxy, perfluoroalkyl, perfluoroalkoxy, arylalkyl, alkylaryl, hydroxyalkyl, alkoxyalkyl, alkylthio, —S(O)₂—N(R^{a})(R^{b}), —C(═O)—N(R^{a})(R^{b}), (R^{a})(R^{b})N-alkyl, (R^{a})(R^{b})N-alkoxyalkyl, (R^{a})(R^{b})N-alkylaryloxyalkyl, —S(O)ₛ— aryl (where s=0-2) or —S(O)ₛ-heteroaryl (where s=0-2). R^{a} and R^{b} are optionally substituted alkyl or aryl.

The invention is illustrated by the following examples which are intended to be illustrative and not limiting.

### Materials

Vinyl chloride (VC, 99%) was purchased from Aldrich. Sodium dithionite (85%) was purchased from Lancaster and stored under N₂. The sodium salt of p-toluenesulfinic acid, hydrate (98+%) was purchased from Acros Organics. 2-Bromopropionyl bromide (97%, Aldrich), ethylene glycol (99+%, Acros), pentaerythritol (98%, Aldrich), pyridine (99.9%, Fisher), thionyl chloride (99.5%, Sigma), bromine (Acros Organics), adipic acid (98%, Acros Organics), sodium iodide (Fisher), methanol (Fisher), 2-methoxyethanol (99+%, Acros Organics), acetone (Fisher) were used as received. Celvol 540 and Methocel K100 were provided by COLORITE. Anhydrous THF (Fisher) was obtained by distillation from sodium benzophenone ketyl under an inert atmosphere of nitrogen.

### Techniques

¹H 500 MHz NMR and HMQC spectra were recorded on Brucker DRX500 NMR and Brucker DMX600, respectively at 20° C. in CD₂Cl₂ (PVC). Gel Permeation Chromatographic (GPC) analysis of PVC samples was performed on Perkin-Elmer Series 10 high performance liquid chromatograph, equipped with LC-100 column oven (40 and 25° C.), Nelson Analytical 900 Series integration data station, Perkin-Elmer 785A UV-Vis detector (254 nm), Varian star 4090 refractive index (RI) detector, and two AM gel (500 Å, 5 μm and 104 Å, 5 μm for low molecular weight samples) columns. THF (Fisher) was used as an eluent at a flow rate of 1 mL/min. The number average molecular weight (Mₙ) and the weight average molecular weight (Mw) of PVC samples were determined with PS standards purchased from Pressure Chemical and were corrected with the Universal Calibration (Hutchinson, et al., DECHEMA Monogr 1995, 131, 467-492 using Mark-Houwink parameters for PVC: K=1.50×10−2 mL/g, a=0.77 (Kurata and Tsunashima, In Polymer Handbook; Brandrup, et al., Eds.; Wiley: New York, 1999, p 1-83).

### Synthesis of Bis(2-bromopropionyloxy)ethane, BBPE

To a 0° C. cooled solution of ethylene glycol (0.047 mol, 2.92 g, 2.62 mL) and pyridine (0.097 mol, 7.67 g, 7.84 mL) in dry THF (30 mL), a solution of 2-bromopropionyl bromide (0.97 mol, 21.02 g, 10.20 mL) in dry THF (10 mL) was added drop-wise under N₂ over a period of 1.5 h. The reaction was allowed to warm up to room temperature overnight. The precipitated salt was filtered off and the solvent was evaporated. The crude product was dissolved in CH₂Cl₂ and the solution was washed with aqueous solution of NaHCO₃, brine and water. The organic layer was separated and dried with Na₂SO₄. The solvent was evaporated and the crude BBPE was purified by column chromatography (silica gel) with hexane/ethyl acetate (9/1) as eluent to yield 11.71 g of colorless oil. Yield: 75%. ¹H NMR (500 MHz, CDCl₃, ppm): δ 1.84 (overlapped d, J=6.9 Hz, 6H, 2CH₃), 4.38-4.46 (m, 6H, 2CH₂ and 4CH). ¹³C NMR (125 MHz, CDCl₃, ppm): 21.68 (2CH₃), 39.74-39.75 (2CH), 63.18 (2CH₂), 170.08 (2C═O).

### Synthesis of Bis(2-iodopropionyloxy)ethane, BIPE

To a solution of NaI (0.462 mol, 69.25 g) in acetone (150 mL) at 25° C., a solution of bis(2 bromopropionyloxy) ethane (BBPE, 0.077 mol, 25.57 g) in acetone (50 mL) was added rapidly. The precipitation of NaBr appeared after approximately 10-20 s. The reaction mixture was stirred until complete disappearance of BBPE on ¹H NMR spectrum. The reaction was complete in 2 h. NaBr was filtered off, the reaction mixture was diluted with water and the product was extracted into CH₂Cl₂. The organic solution was washed with 2% aqueous solution Na₂SO₃ followed by brine and water. The organic layer was separated and dried with Na₂SO₄. The solvent was evaporated and the crude product was purified on silica gel plug with hexane/ethyl acetate (9/1) as eluent to yield 25.57 g of colorless oil which darkened quickly to orange. Yield: 78%. ¹H NMR (500 MHz, CDCl₃, ppm): δ 1.98 (overlapped d, J=7.0 Hz, 6H, 2CH₃), 4.38 (unresolved t, J=1.01 Hz, 4H, CH₂CH₂), 4.51 (overlapped quartet, J=7.0 Hz, 2H, 2CH). ¹³C NMR (125 MHz, CDCl, 3, ppm): 12.51-12.54 (2 CH₃), 23.40 (2 CH), 63.00 (2CH₂), 171.76 (2C═O).

### Synthesis of Pentaerythritol Tetrakis(2-bromopropionate) 4BrPr

To a 0° C. cooled solution of pentaerythritol (0.075 mol, 10.21 g) and pyridine (0.303 mol, 24.96 g, 24.5 mL) in dry THF (220 mL), a solution of 2-bromopropionyl bromide (0.303 mol, 65.4 g, 32.06 mL) in dry THF (30 mL) was added drop-wise in the atmosphere of N₂ over a period of 2 h. The reaction was allowed to warm up to room temperature overnight. The precipitated salt was filtered and the solvent was evaporated. The crude product was recrystallized from EtOH to yield 37.78 g of white solid. Yield: 75%. ¹H NMR (500 MHz, CDCl₃, ppm): δ 1.83 (d, J=6.9 Hz, 12H, 4CH₃), 4.21-4.38 (m, 8H, 4CH₂), 4.40 (quartet, J=6.9 Hz, 4H, 4CH). ¹³C NMR (125 MHz, CDCl₃, ppm): 21.65 (4CH₃), 39.51-39.58 (4CH), 43.40-44.43.42 (C(CH₂)₄), 63.18-63.21 (4CH₂), 169.63-169.66 (4C═O).

### Synthesis of Pentaerythritol Tetrakis(2-iodopropionate), 4IPr

To a solution of NaI (0.09 mol, 13.50 g) in acetone (150 mL) at 25° C., a solution of pentaerytritol tetrakis(2-bromopropionate) (4BrPr, 0.015 mol, 10.14 g) in acetone (100 mL) was added rapidly. The precipitation of NaBr appeared after approximately 10-20 s. The reaction mixture was stirred until complete disappearance of 4BrPr on ¹H NMR. The reaction was complete in 6 h. NaBr was filtered off, the solvent was evaporated and the crude product was passed through a short silica gel plug with CH₂Cl₂ as eluent, followed by recrystallization from MeOH to yield 9.59 g of pale yellow solid. Yield: 74%. ¹H NMR (500 MHz, CDCl₃, ppm): δ 1.97 (overlapped d, J=7.0 Hz, 12H, 4CH₃), 4.17-4.37 (m, 8H, (4CH₂), 4.52 (overlapped quartet, J=6.1 Hz, 4H, (4-CH). ¹³C NMR (125 MHz, CDCl₃, ppm): 12.06-12.15 (4CH₃), 23.40 (4CH), 43.57-44.59 (C(CH₂)₄), 63.11-63.15 (4CH₂), 171.28-171.33 (4C═O).

### Synthesis of Dimethyl 2,5-Dibromohexanedioate, DMDBH

Adipic acid (0.050 mol, 7.31 g) and SOCl₂ (0.125 mol, 14.87 g, 9.1 mL) were refluxed (80° C.) until the evolution of HCl and SO₂ neutralized in 5 M aqueous solution of NaOH ceased (approximately after 2 h). The excess of SOCl₂ was removed under reduced pressure. The temperature of the reaction was increased to 85° C. and bromine (0.125 mol, 19.98 g, 6.4 mL) was added drop-wise over a period of 6 h followed by additional stirring at 85° C. until the disappearance of intermediates on ¹H NMR spectrum. The reaction was complete in 3 h. The hot bromide derivative was subsequently added drop-wise to 80 mL of MeOH cooled at 0° C. with an ice-bath. The solution was warmed to room temperature overnight and poured into ice-water. The crude product was extracted into CH₂Cl₂. The organic layer was washed with 2% aqueous solution of Na₂SO₃ followed by the aqueous solution of NaHCO₃ and water. The organic layer was separated and dried with Na₂SO₄. The solvent was evaporated and the product was recrystallized from MeOH to yield 12.94 g of white solid. Yield: 78%. ¹H NMR (500 MHz, CDCl₃, ppm): 2.09-2.11 (m, 2H, CH₂), 2.32-2.34 (m, 2H, CH₂), 3.82 (s, 6H, 2CH₃), 4.27-4.30 (m, 2CH). ¹³C NMR (125 MHz, CDCl₃, ppm): 32.66 (CH₂CH₂), 44.44 (2CHI), 53.31 (2OCH₃), 169.82 (2C═O).

### Synthesis of Bis(2-methoxyethyl) 2,5-Dibromohexanedioate, BMEDBH

Adipic acid (0.050 mol, 7.31 g) and SOCl₂ (0.125 mol, 14.87 g, 19.1 mL) were refluxed (80° C.) until the evolution of HCl and SO₂ neutralized in 5 M aqueous solution of NaOH ceased (approximately after 2 h). The excess of SOCl₂ was removed under reduced pressure. The temperature of the reaction was increased to 85° C. and bromine (0.125 mol, 19.98 g, 6.4 mL) was added drop-wise over a period of 2 h followed by additional stirring at 85° C. until the disappearance of the intermediate product in the ¹H NMR spectrum. The reaction was complete in 4 h. The hot bromide was subsequently added drop-wise to 80 mL of MeOH cooled at 0° C. in an ice-bath. The solution was warmed to room temperature overnight and poured into ice-water. The crude product was extracted into CH₂Cl₂. The organic layer was washed with 2% aqueous solution of Na₂SO₃ followed by an aqueous solution of NaHCO₃ and water. The organic layer was separated and dried with Na₂SO₄. The solvent was evaporated and the product was recrystallized from MeOH to yield 17.04 g of white solid. Yield: 81%. ¹H NMR (500 MHz, CDCl₃, ppm): δ 2.08-2.32 (m, 4H, CH₂CH₂), 3.39 (m, 6H, 2OCH₃), 3.61-3.63 (m, 4H, 2OCH₂), 4.26-4.31 (m, 2H, 2CH), 4.32-4.35 (m, 4H, 2CH₂COO). ¹³C NMR (125 MHz, CDCl₃, ppm): 32.40-32.60 (CH₂CH₂), 44.47-44.52 (2CHI), 59.25 (2OCH₃), 65.24-65.26 (2CH₂COO), 70.24 (2OCH₂), 169.25 (2C═O).

### Synthesis of Dimethyl 2,5-Diiodohexanedioate, DMDIH

To a solution of NaI (0.0405 mol, 6.07 g) in acetone (100 mL) at 25° C., a solution of dimethyl 2,5-dibromohexanedioate (DMDBH, 0.0135 mol, 4.48 g) in acetone (50 mL) was added rapidly. The precipitation of NaBr appeared after approximately 10-20 s. The reaction mixture was stirred until complete disappearance of DMDBH in the ¹H NMR spectrum. The reaction was complete in 4 h. NaBr was filtered off, the solvent was evaporated and the crude product was passed through a short silica gel plug with CH₂Cl₂ as eluent, followed by recrystallization from MeOH to yield 4.53 g of white crystals. Yield: 79%. ¹H NMR (500 MHz, CDCl₃, ppm): 1.92-2.01 (m, 2H, CH₂), 2.13-2.20 (m, 2H, CH₂), 3.76 (s, 6H, 2CH₃), 4.29-4.36 (m, 2CH). ¹³C NMR (125 MHz, CDCl₃, ppm): 18.05-18.35 (2CHI), 35.66-35.85 (CH₂CH₂), 53.20 (2OCH₃), 171.45 (2C═O).

### Synthesis of Bis(2-methoxyethyl) 2,5-Diiodohexanedioate, BMEDIH

To a solution of NaI (0.0225 mol, 3.37 g) in acetone (70 mL) at 25° C., a solution of bis(2-methoxyethyl) 2,5-dibromohexanedioate (BMEDBH, 0.0075 mol, 3.15 g) in acetone (30 mL) was added rapidly. The precipitation of NaBr appeared after approximately 10-20 s. The reaction mixture was stirred until complete disappearance of BMEDBH in ¹H NMR spectrum. The reaction was complete in 2 h. NaBr was filtered off, the filtrate was diluted with water and product was extracted into CH₂Cl₂. The organic layer was separated washed with 2% aqueous solution of Na₂SO₃ followed by brine and water. The organic layer was separated and dried with Na₂SO₄. The solvent was evaporated and the crude product was purified on silica gel plug with hexane/ethyl acetate (9/1) as eluent. No recrystallization was possible due to the very low melting point of the product. However, the product solidified upon standing to yield 3.59 g of pale yellow solid. Yield: 93%. ¹H NMR (500 MHz, CDCl₃, ppm): δ 1.99-2.18 (m, 4H, CH₂CH₂), 3.40-3.41 (m, 6H, 2OCH₃), 3.58-3.65 (m, 4H, 2OCH₂), 4.27-4.33 (m, 4H, 2CH₂COO), 4.33-4.37 (m, 2H, 2CH). ¹³C NMR (125 MHz, CDCl₃, ppm): 18.22-18.55 (2CHI), 35.57-35.75 (CH₂CH₂), 59.22 (2OCH₃), 64.98-64.99 (2CH₂COO), 70.15 (2OCH₂), 171.05-171.08 (2C═O).

### Typical Procedure for the Na₂S₂O₄ Catalyzed SET-DTLRP of VC in Water in a Presence of Celvol 540 and Methocel K100

Celvol 540 (0.293 g in 1 mL water stock solution), Methocel K100 (0.110 g in 1 mL water stock solution) and water (7 mL) were placed in a 50 mL Ace Glass 8648 #15 Ace-thred pressure tube equipped with bushing and plunger valve. The content of the tube was degassed by six freeze-pump-thaw cycles in acetone/dry ice. The tube was filled with nitrogen and frozen. Initiator (BIPE, 42.6 mg, 17.2 μL, 0.1 mmol), catalyst (Na₂S₂O₄, 34.8 mg, 0.2 mmol), buffer (NaHCO₃, 18.5 mg, 0.22 mmol) and precondensed VC (3.3 mL) were added. The tube was closed and degassed through the plunger by applying reduced pressure and filling the tube with nitrogen 20 times at −78° C. in an acetone/dry ice bath. The exact amount of vinyl chloride (VC) (˜2.2 g, 35.2 mmol) was determined gravimetrically by weighing the tube before the addition of precondensed VC and after degassing. After the content was degassed the tube was closed and the reaction mixture was stirred at 25° C.±0.5° C. The polymerization experiments were carried out in a hood behind a protective shield. After 6 h, the tube was slowly opened. In the case of intensive VC release the tube was frozen and then slowly opened. The excess of VC was allowed to evaporate and the suspension was filtered. The polymer was washed with water followed by methanol and dried in a vacuum oven at 25° C. to yield 0.47 g (21%) of white PVC powder with Mₙ=9,385 (value calibrated with Universal Calibration for PVC) and M_{w}/Mₙ=2.01.

### Synthesis of Bifunctional and Tetrafunctional Initiators

The synthesis of bromo-terminated bifunctional and tetrafunctional initiators bis(2-bromopropionyloxy)ethane (BBPE) and pentaerythritol tetrakis(2-bromopropionate) (4BrPr) is outlined in Scheme 1. Both bifunctional and tetrafunctional initiators were prepared via acylation of ethylene glycol and pentaerythritol, respectively, with a stoichiometric amount of 2-bromopropionyl bromide in dry THF in the presence of dry pyridine. Triethylamine (TEA) also can be used. However, TEA mediates the formation of secondary products. The iodo-terminated derivatives were generated from the brominated initiators bis(2-iodopropionlyloxy) ethane (BIPE) and pentaerythritol tetrakis(2-iodopropionate) (4IPr) (Scheme 1) by the Finkelstein halogen exchange reaction33 with NaI in acetone at 25° C. Over 74% yield was obtained in 2 to 6 h of reaction at 25° C.

Few additional bifunctional initiators were also synthesized. Scheme 2 shows the synthesis of these bifunctional initiators.

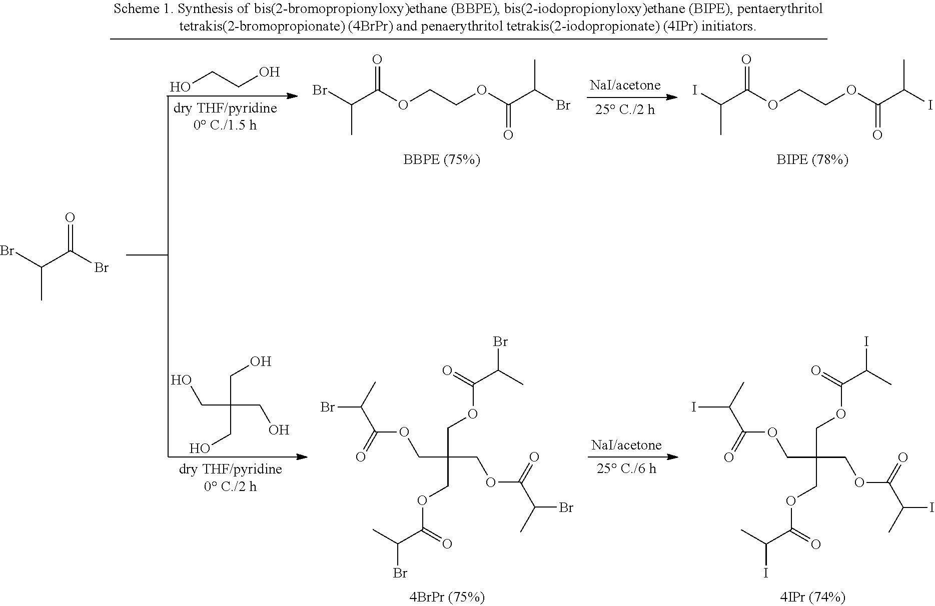

One of the least expensive precursors for the synthesis of bifunctional initiators is adipic acid. Two iodo-terminated bifunctional initiators, dimethyl 2,5-diiodohexanedioate (DMDIH) and bis(2-methoxyethyl)-2,5-diiodohexanedioate (BMEDIH) were synthesized according to a modified literature method starting from adipic acid. See, Guha and Sankaran, Org Synth 1955, Coll Vol 3, 623-627. BMEDIH was synthesized for structural investigations since its ¹H NMR resonances do not overlap with those of the backbone of PVC.

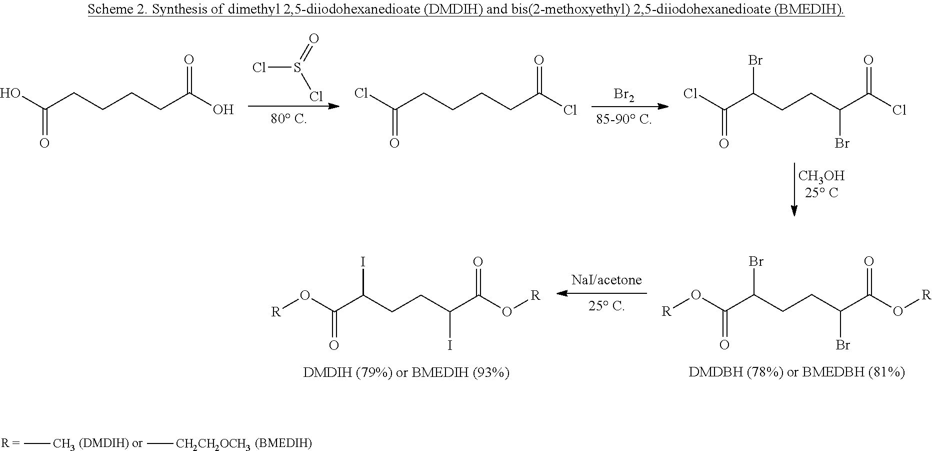

Both DMDIH and BMEDIH initiators were synthesized in four-steps two pot reaction. DMDIH and BMEDIH were prepared from commercially available adipic acid, which was converted to the corresponding acid chloride via treatment with thionyl chloride at ˜80° C. in bulk. Without further purification the acid chloride was brominated via drop-wise addition of Br₂ at 85-90° C. These two steps were performed in one pot. Without further purification the product of the bromination was esterified with methanol and 2-methoxyethanol, respectively. For the purpose of mechanistic and structural studies the choice of these two alcohols was based on their ¹H NMR spectra, that revealed the presence of chemical shifts associated with —CH₂—OCH₃ and —OCH₃ groups in a region, which do not overlap with the backbone of PVC. This allows for an accurate analysis of the polymer structure. Both bromo-terminated bifunctional initiators were isolated and converted into iodo-terminated bifunctional initiators by the Finkelstein iodine exchange reaction. Percec, et al., J. Polym Sci Part A: Polym Chem 2005, 43, 773-778; The complete exchange of Br to I based on ¹H NMR analysis was achieved in 2 to 4 h in acetone at 25° C. The pure products were obtained in higher than 79% yield after recrystallization from MeOH.

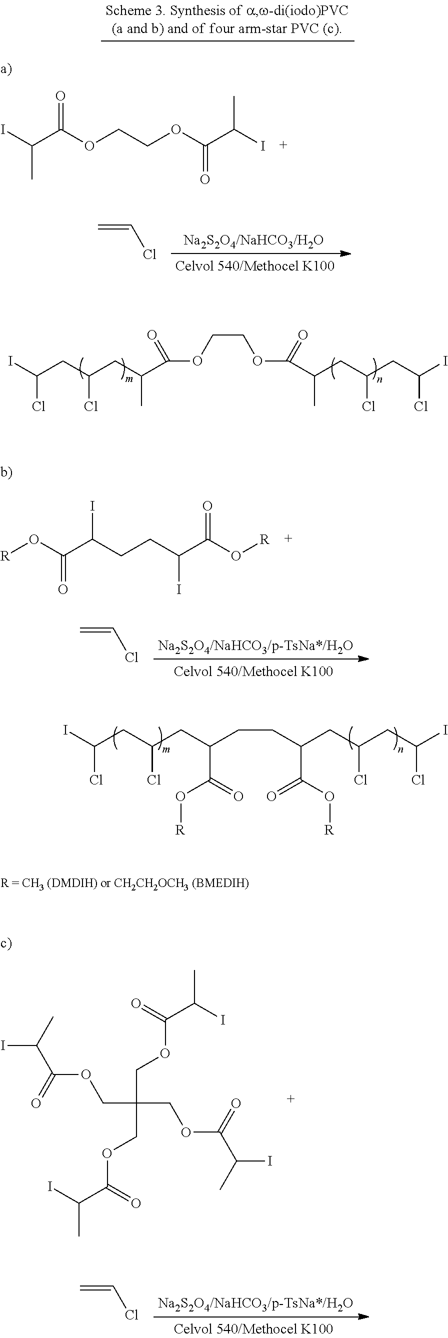

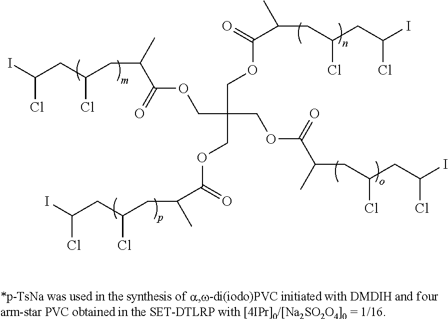

SET-DTLRP of VC Initiated with BIPE and Catalyzed by Na₂S₂O₄

All kinetic experiments were carried out in 50 mL glass Ace Glass 8648 #15 high pressure tubes equipped with bushing and a plunger valve. Each data point on the kinetic plots represents a single experiment. All polymerizations were performed in water in the presence of two surfactants: polyvinyl alcohol (4.99% in H₂O Celvol 540) and hydroxypropylmethylcellulose (4.20% in H₂O Methocel K100). The surfactant were used in the ratio Celvol 540/Methocel K100=0.7 parts per monomer/0.2 parts per monomer in respect to VC. Thus, for 1 g of VC 0.007 g of solid Celvol 540 and 0.2 g of solid Methocel K100 were used. In addition, each polymerization was performed in the presence of NaHCO₃ as a buffer, which maintains a basic pH of the reaction to prevent the decomposition of Na₂S₂O₄ as well as to consume SO₂ produced after the oxidation of SO₂⁻.radical anion. SET-DTLRP of VC does not proceed in the absence of NaHCO₃. The synthesis of this PVC is shown in Scheme 1a.

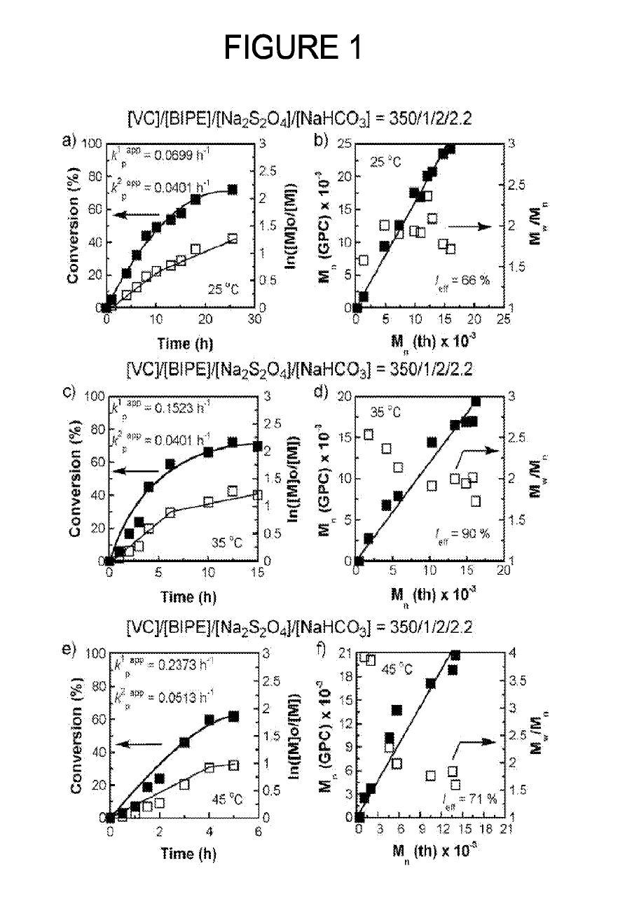

FIG. 1 illustrates the kinetic plots for Na₂S₂O₄ catalyzed SET-DTLRP of VC initiated with BIPE bifunctional initiator in water in the presence of surfactants (Celvol 540 and Methocel K100) at various temperatures with the initial molar ratio [VC]₀/[BIPE]₀=350. As expected, all polymerizations reached over 60% monomer conversion. The rate of the polymerization increased with increasing temperature. The kinetic data presented in FIG. 1a,c,e exhibit two slopes in the ln([M]₀/[M]) versus time plots. [M]₀ is the initial monomer concentration and [M] in the monomer concentration at time t. The k¹ₚ^{app} corresponds to a liquid-liquid emulsion polymerization, where VC from the organic liquid phase is in equilibrium with VC from the gas phase and the water phase. The k₂^{p}ₐₚₚ value corresponds to a solid-liquid suspension polymerization, where VC in a gas phase is in equilibrium with a solution in water and precipitated PVC. Both apparent rate constants of propagation k¹ₚ^{app} and k²ₚ^{app} are shown in the conversion versus time kinetic plots. The transition from a faster k¹ₚ^{app} to a slower k²ₚ^{app} polymerization process occurs at a conversion of approximately 49%-60%. This is associated with the formation of PVC particles. The linear time dependence of ln([M]₀/[M]) indicates a first order rate of propagation in growing radical species and monomer concentrations. In addition, the linear increase of the number-average molecular weight determined by gel permeation chromatography (GPC) Mₙ^{GPC} versus the theoretical molecular weight Mₙ^{th}=DP^{th}·Mᵣᵤ·p+Mᵢₙ, where DP^{th}=[M]₀/[I]₀—theoretical degree of polymerization, Mᵣᵤ—molecular weight of the monomer repeat unit, p—monomer conversion and Mᵢₙ—molecular weight of initiator, supports the living character of these polymerizations. The increase of the temperature of the polymerization in one attempt to produce a higher rate of polymerization had an unfavorable influence on the linear dependence of Mₙ^{GPC} versus Mₙ^{th}.

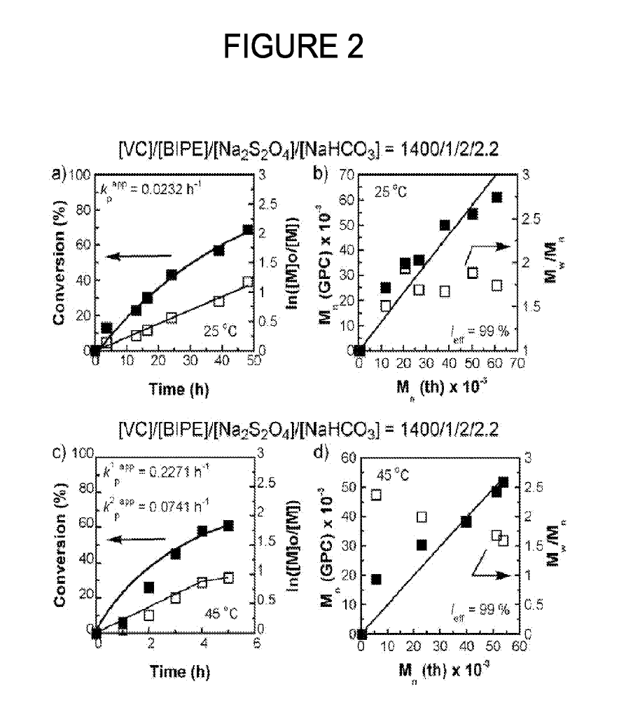

FIG. 2 shows two additional kinetic experiments for the polymerization of VC by SET-DTLRP utilizing BIPE as bifunctional initiator with the molar ratio of [VC]₀/[BIPE]₀=1400 performed at 25 and 45° C. Polymerizations with [M]₀/[I]₀=1440 revealed a living process. The kinetic data in FIG. 2a demonstrates a three times slower process than in the polymerization with [M]./[I]₀=350 at 25° C., showing the apparent rate constant kₚ^{app}=0.0232 h⁻¹ in comparison to kₚ^{app}=0.0699 h⁻¹ (FIG. 1a).

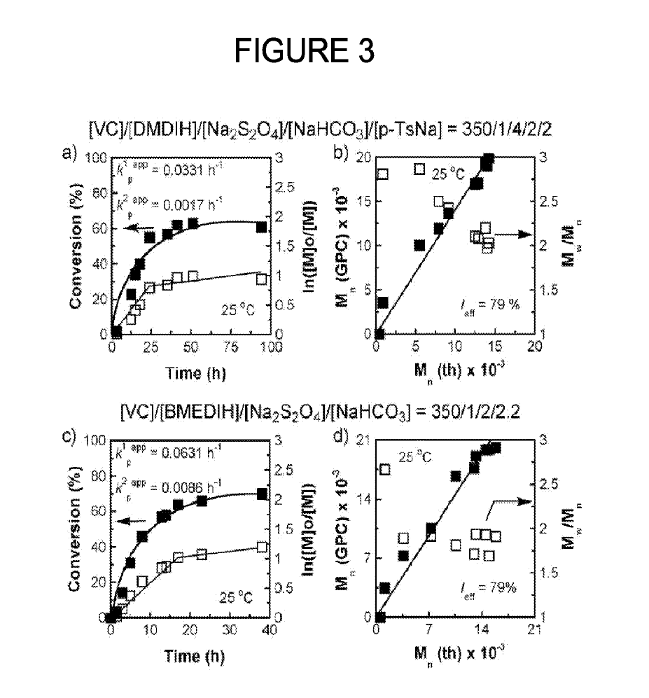

The two slopes corresponding to liquid-liquid emulsion and solid-liquid suspension polymerizations on the ln([M]₀/[M]) versus time plot (FIG. 2a) were not very pronounced. Therefore, only one value of the apparent rate constant of propagation is presented. Polymerization at 45° C. with [M]₀/[I]₀=1400 proceeded similarly to the polymerization with [M]₀/[I]₀=350 at 45° C. There is only a small difference between the values of kₚ^{app} for both experiments collected at 45° C. with [M]₀/[I]₀=350 and [M]0/[I]0=1400. Also the number-average molecular weight Mₙ of PVC follows a slightly distorted linear dependence on the conversion. The values of Mₙ^{GPC} are very close to the theoretical Mₙ^{th} values. Thus, the initiator efficiency I_{eff} for the polymerization of VC with [M]₀/[I]₀=1400 at 45° C. is closer to 100% than the one observed in the polymerization with [M]₀/[I]₀=350. Both DMDIH and BMEDIH bifunctional initiators were tested in the polymerization of VC by SET-DTLRP. The synthesis of these PVC is shown in Scheme 3b. The kinetic data for both polymerizations are shown in FIG. 3. The conditions for both polymerizations were marginally different in terms of the amount of the catalyst ([DMDIH]₀/[Na₂S₂O₄]₀=1/4, while [BMEDIH]₀/[Na₂S₂O]₀=1/2). In the polymerization initiated with DMDIH, p-TsNa was used as an additive. The addition of p-TsNa was reported to enhance the reproducibility of the polymerization experiments as well as to provide polymers with narrower molecular weight distribution. Percec, et al., J Polym Sci Part A: Polym Chem 2004, 42, 6267-6282. Mw/Mn=1.6-1.7 in the presence of p-TsNa and M_{w}/Mₙ=2.0-2.2 in the absence of p-TsNa in SET-DTLRP of VC with CH_{1S} as initiator in water at 35° C. However, in the case of the polymerization of VC with DMDIH as initiator the molecular weight distribution did not decrease significantly below M_{w}/Mₙ=2.00. In the SET-DTLRP of VC initiated with BMEDIH performed in the absence of p-TsNa, the molecular weight distribution was in the range of 1.80-2.00. Also the molecular weight distribution Mw/Mn for SET-DTLRP of VC initiated with BIPE (FIGS. 1 and 2) was below 2.00 in the absence of p-TsNa. These observations indicate that most probably p-TsNa does not have a substantial influence on the molecular weight distribution of PVC obtained by SET-DTLRP in water when initiation is performed with various iodo-terminated bifunctional initiators. However, as stated previously p-TsNa may act as a scavenger of iodine obtained by the slow decomposition of iodo-terminated bifunctional initiators. Thus, the presence of p-TsNa may help to prevent some undesirable side reactions. Polymerization of VC initiated with DMDIH reached 60% conversion after ˜40 h (FIG. 3a). When BMEDIH was used, the reaction reached ˜60% conversion after only 14 h and increased to 70% within the next 24 h (FIG. 3c). Both sets of experiments showed two stages of the polymerization marked as two distinct slopes in the conversion versus time kinetic graphs. They correspond to k¹ₚ^{app}=0.0331 h⁻¹ and k²ₚ^{app}=0.0017 h⁻¹ for SET-DTLRP initiated with DMDIH and k¹ₚ^{app}=0.0631 h−1 and k²ₚ^{app}=0.0086 h⁻¹ for SET-DTLRP initiated with BMEDIH (FIG. 3a,c). The rate of polymerization changed at 55% to 60% conversion after 40 h and 14 h, respectively, which is slightly different from what was observed for BIPE (FIG. 1a,c,e).

The efficiency of both DMDIH and BMEDIH bifunctional initiators is 79% which is similar to the efficiency of BIPE in the corresponding polymerization carried out at 25° C.

### Structural Analysis of Bifunctional PVC

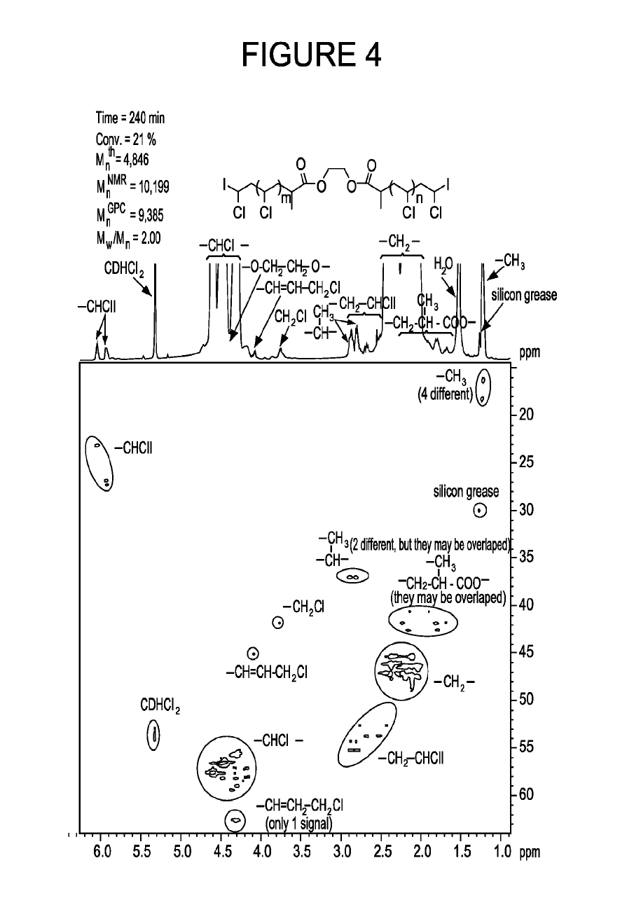

The structure of PVC obtained by SET-DTLRP of VC and initiated by BIPE bifunctional initiator was elucidated by a combination of one-dimensional (1D) ¹H and ¹³C NMR spectroscopy and two-dimensional (2D) Heteronuclear Multiple Quantum Coherence (HMQC) methods. FIG. 4 shows the HMQC analysis of the PVC sample obtained at 21% conversion during the Na₂S₂O₄ catalyzed polymerization of VC by SET-DTLRP in water initiated with BIPE. All proton assignments are shown on the ¹H NMR and HSQC spectra. The ¹H NMR analysis revealed two strong signals related to PVC main chain in the range of 2.01 ppm-2.47 ppm (˜CH₂˜) and 4.30 ppm−4.61 ppm (˜CHCl˜). The middle part of the polymer represented by the ˜O—CH₂—CH₂—O˜derived from the BIPE bifunctional initiator overlapped with peaks attributed to ˜CHCl˜. Its presence was revealed only in the HSQC spectrum at 4.30 ppm; 63 ppm. The two multiplets at 2.80 ppm; 37 ppm and 2.87 ppm; 37 ppm are due to the ˜CH(CH₃)˜ fragments of the bifunctional initiator. These multiplets partially overlap with multiplets corresponding to CH₂ groups (˜CH₂—CHClI) neighboring the chain ends.

The ˜CH₃ groups of the initiator were detected at 1.22 ppm. The ˜CH₂CH(CH₃)C(O)O˜ groups as part of the PVC backbone next to the initiator partially overlap with the signal corresponding to ˜CH₂˜backbone of the PVC. Finally the two signals at 5.92 ppm and 6.04 ppm were assigned to the stereoisomers r and m of ˜CHClI chain ends. The two chain ends are identical. Finally the ¹H NMR analysis of the sample showed only very small levels of structural defects, which were recorded at 4.08 ppm (trans-CH═CHCH₂Cl). The multiplets at 3.68-3.87 belong to ˜CH₂Cl groups. The very weak signal at 5.76-5.88 represents the ˜CH═CH˜ moiety.

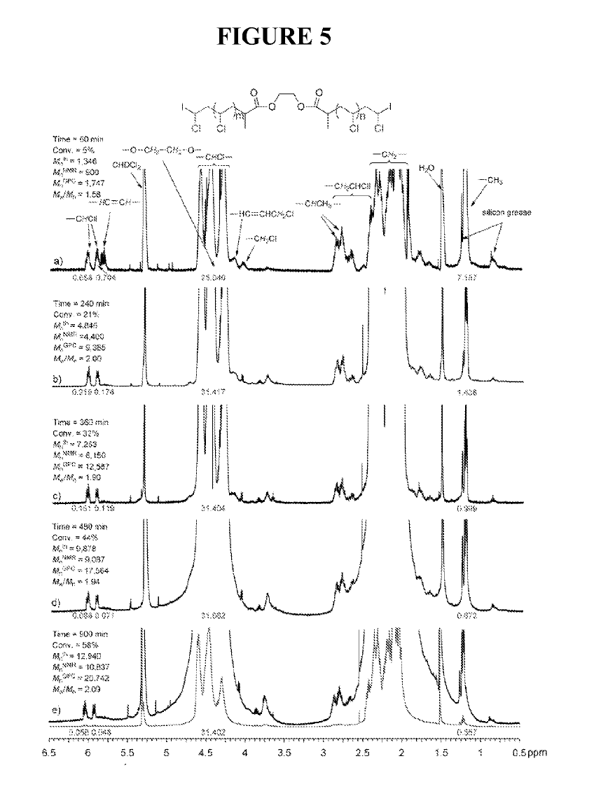

As can be seen in the collection of ¹H NMR spectra of PVC samples obtained by the SET-DTLRP of VC initiated with BIPE at 25° C. in water (FIG. 5) the amount of all structural defects is almost undetectable (ex. ˜CH═CH˜) or they appear at the noise level. The relatively low amount or complete absence of structural defects significantly improves the stability of PVC. The ¹H NMR analysis was also used for the calculation of the molecular weight of the selected samples based on the integration ratio between ˜CH₃ groups of the initiator and from ˜CHCl˜ which is a part of the polymer backbone. The Mₙ calculated from the ¹H NMR spectrum Mₙ^{NMR} along with other data obtained based on the GPC analysis as well as the integration values are incorporated in FIG. 5. The molecular weight calculated form ¹H NMR confirmed the living polymerization process showing the increasing molecular weight with conversion. However, the Mₙ^{NMR} values calculated based on the NMR analysis were slightly lower than the theoretical values and also lower than the values obtained by GPC analysis. All samples show the presence of the active chain ends at approximately 6 ppm.

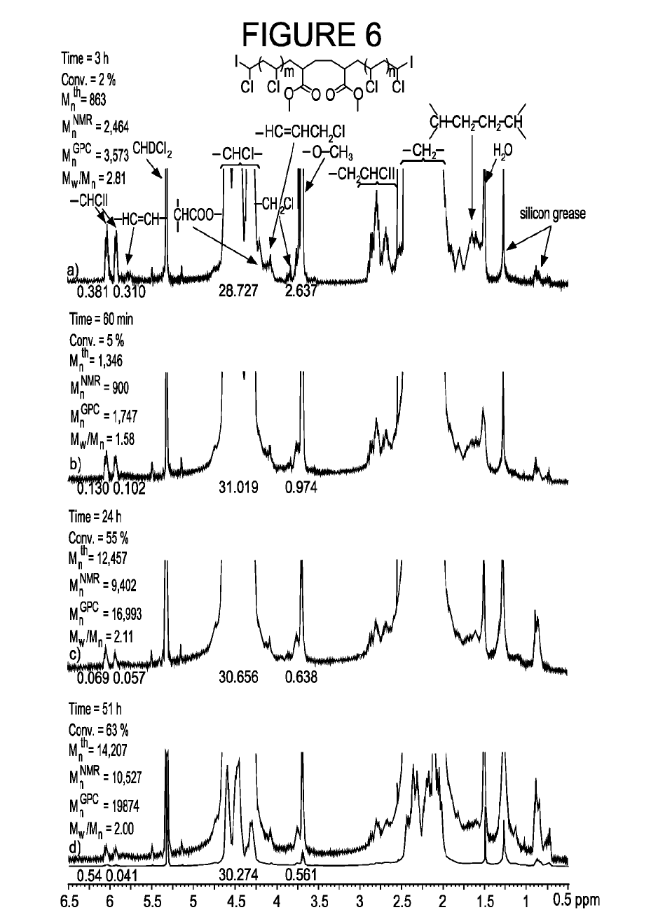

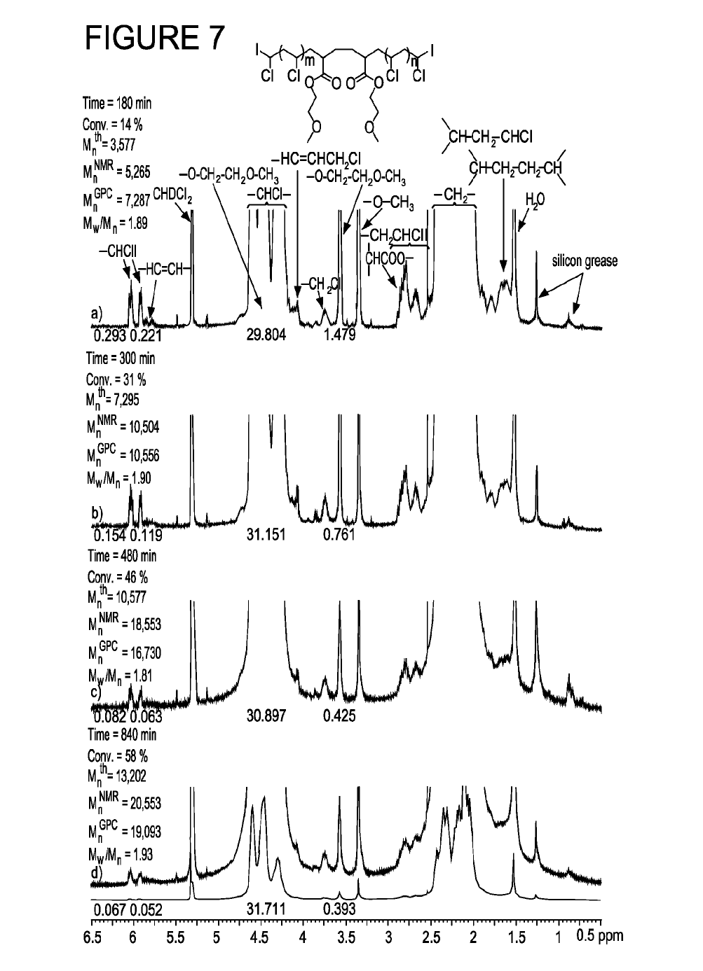

FIGS. 6 and 7 show the ¹H NMR analysis of the series of PVC samples obtained by SET-DTLRP using DMDIH and BMEDIH as bifunctional initiators respectively. All samples revealed the presence of active —CHClI chain ends detected similarly as in other polymerizations of VC initiated with iodo-terminated initiator at ˜6 ppm and suitable for further functionalization and polymerization. Structural defects are also present in very insignificant amounts at the noise level of the ¹H NMR spectra. Only at the low conversion the peaks representing the structural defects are more pronounced in comparison to the chain end peaks of the polymer.

The general structural features observed in the ¹H NMR spectrum of PVC prepared by SET-DTLRP in water and initiated with DMDIH and BMEDIH are identical to PVC obtained in the polymerization initiated by BIPE and CHI₃. The only observable difference in all samples are peaks representing various parts of initiators. Both FIG. 6 and FIG. 7 display the assignment of all peaks representing different groups from the structure of the polymer.

### Synthesis of Four-Arm Star PVC and Structural Analysis

One of the primary advantages of the SET-DTLRP methodology its flexibility in the design of experiments for the synthesis of polymers with different topologies. Various polymer topologies are accessible via the structure of the initiator. SET-DTLRP was used in the preparation of four-arm star PVC using 4IPr as a tetrafunctional initiator (Scheme 1, 4IPr).

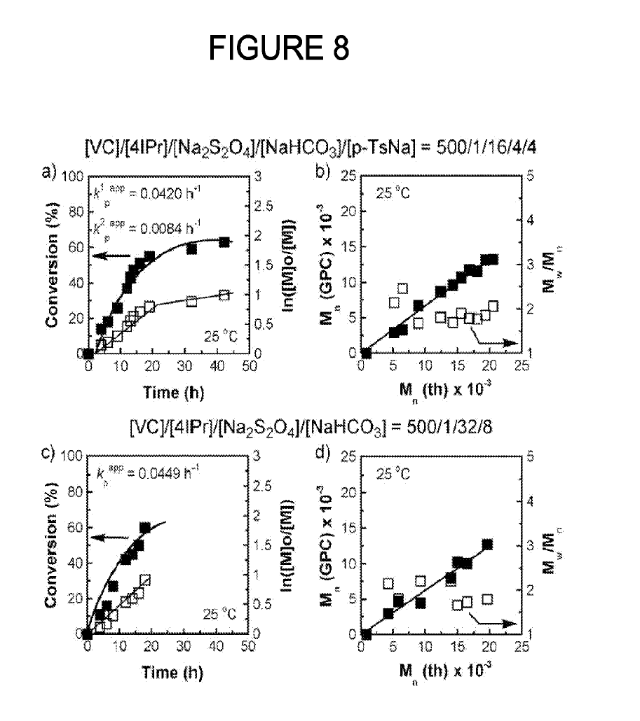

The kinetic data for the polymerization of VC with [VC]₀/[4IPr]₀=500 performed in water in the presence of Celvol 540 and Methocel K100 surfactants in the amounts used previously for the polymerization with bifunctional initiators and using Na₂S₂O₄/NaHCO₃ catalytic system are presented in FIG. 8. The synthesis of four-arm star PVC is shown in Scheme 3c. The monomer conversion reached approximately 60% after ˜17 h. The polymerization in FIG. 8a,b exhibits two distinct slopes. The initial slope k¹ₚ^{app}=0.0420 h−1 corresponds to liquid-liquid emulsion polymerization and the second slope kₚ^{app}=0.0084 h−1 is related to a solid-liquid suspension polymerization. Both apparent rate constant values kₚ^{app} are shown on the kinetic plots. The dependence of the number average molecular Mₙ^{GPC} versus theoretical molecular weight Mₙ^{1h} is linear, implying a living process.

The kinetic data presented in FIG. 8 shows that there is only a small increase in the reaction rate while increasing the molar ratio of [VC]/[Na₂S₂O₄] from 500/16 to 500/32. Also the addition of p-TsNa did not show a significant difference in the molecular weight distribution between these two sets of experiments. Thus as previously reported (Coelho, et al., J Polym Sci Part A: Polym Chem 2006, 44, 2809-2825; in the case of SET-DTLRP of butyl acrylate there is a control loading level Na₂S₂O₄. After a certain Na₂S₂O₄ concentration is reached in the polymerization mixture, the polymerization rate is constant. Based on the results obtained here and shown in FIG. 8, this statement is also valid for the polymerization of VC by SET-DTLRP. Further, the addition of p-TsNa did not decrease the M_{w}/Mₙ value.

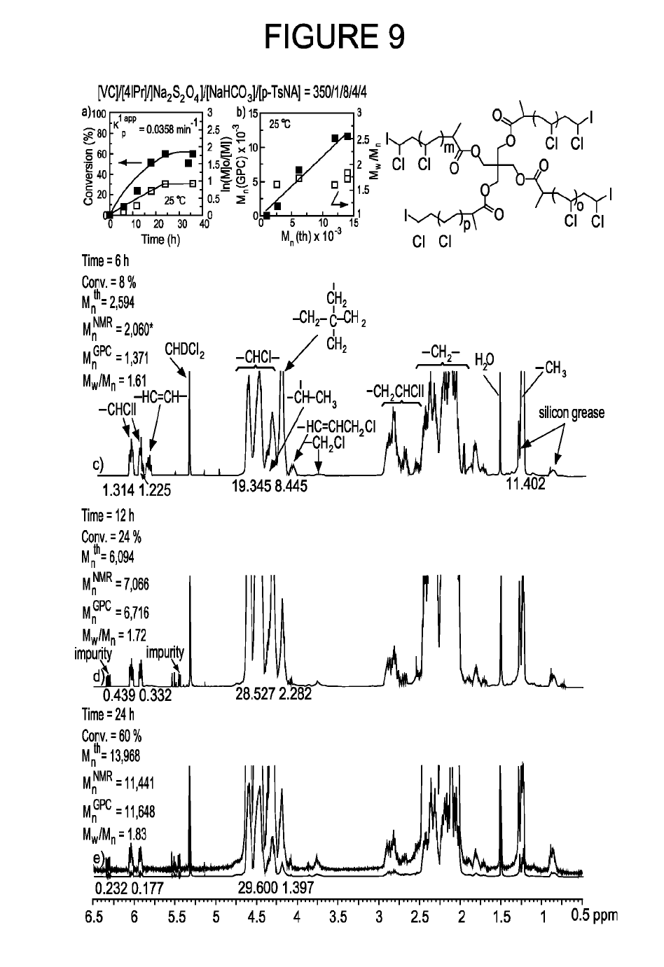

FIG. 9 shows the ¹H NMR analysis of the selected samples of four arm-star PVC prepared by SET-DTLRP of VC with initial ratio of [VC]₀/[4IPr]₀=350. The kinetic data and the structure of the resulting polymer are incorporated on the top of FIG. 9. Several kinetic data points collected in this experiment correspond to the experiments presented in FIG. 8.

The structure of PVC obtained by SET-DTLRP initiated with the tetrafunctional 4IPr initiator is very similar to the PVC structures from the previous polymerizations performed with bifunctional initiators. The only difference consists in the presence of resonances corresponding to the tetrafunctional part of the initiator. The assignments of all peaks are shown in FIG. 8. The molecular weight (Mₙ^{GPC}) was calculated also based on the ratio of CH₃ at 1.25 ppm and ˜CHCl₂˜. The ¹H NMR calculation as well as GPC data (Mₙ^{GPC} and M_{w}/Mₙ) are included in FIG. 9. Similarly as in the polymerizations with bifunctional initiators the structural defects were seen only at the early stages of the polymerization at very low conversion. At higher conversion the structural defects were not detectable or were present only at the ¹H NMR spectrum noise level.

The SET-DTLRP of VC initiated with various multifunctional initiators BIPE, DMDIH, BMEDIH and 4IPr provides PVC with identical and active chloriodomethyl chain ends that are suitable for further functionalization and block copolymerization. PVC obtained by this methodology are free of structural defects or contain them at the level of the resolution of the ¹H NMR analysis. These difunctional and tetrafunctional PVC represent the first examples reported in the literature and are precursors for the synthesis of unprecedented ABA block copolymers and four arm-star block copolymers based on PVC that previously were not accessible by any other synthetic method.

### Synthesis of the Four-Arm Star PBA Macroinitiator

Pentaerythritol tetrakis(2-iodopropionate) (4IPr) was synthesized by the sequence of reactions outlined in Scheme 1. The tetrafunctional initiator 4IPr was obtained by the esterification of pentaerythritol, with a stoichiometric amount of 2-bromopropionyl bromide in dry THF in the presence of dry pyridine, followed by the Finkelstein halogen exchange reaction with NaI in acetone at 25° C. A 74% yield was obtained in 6 h at 25° C. This initiator slowly decomposes upon standing at room temperature changing color to yellow. Preferably it should be freshly recrystallized from MeOH before polymerization.

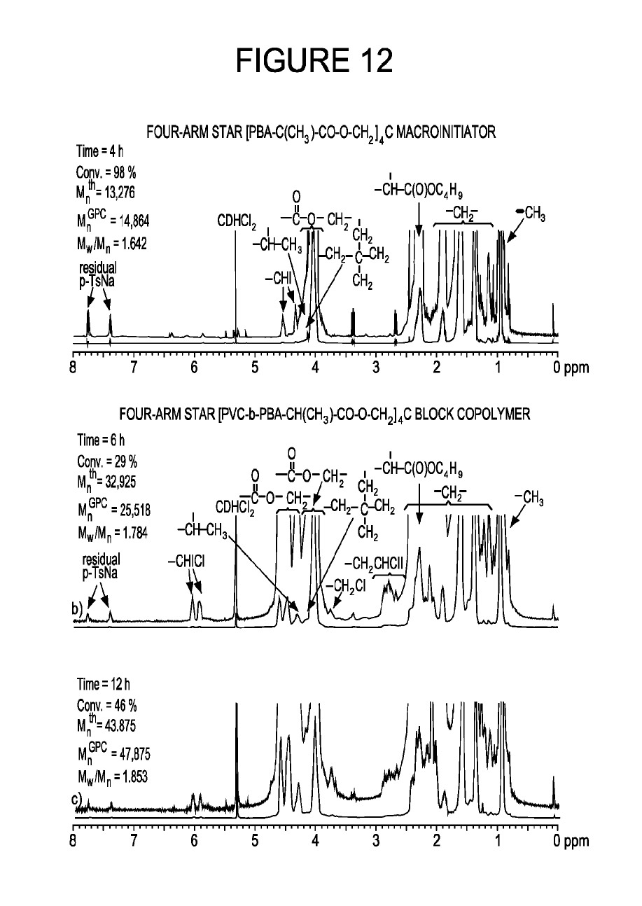

4IPr initiator was used for the synthesis of the four-arm star PBA macroinitiator [PBACH(CH₃)—CO—O—CH₂]₄C by the SET-DTLRP of BA initiated with 4IPr in water at 25° C. and catalyzed by Na₂S₂O₄ (Scheme 4). The initial [BA]₀/[4IPr]₀ ratio used in this polymerization was 100. The polymerization was interrupted at 97% conversion to yield a four-arm star PBA with Mₙ=14,864 and M_{w}/Mₙ=1.642. ¹H NMR analysis of this four-arm star PBA macroinitiator is shown in FIG. 12 and confirms the structure of a four-arm star PBA with four identical ˜CHI—C(O)C₄H₉ and four —CH(CH₃)—CO—O—CH₂— groups attached to the branching point of the four-arm star initiator rest.

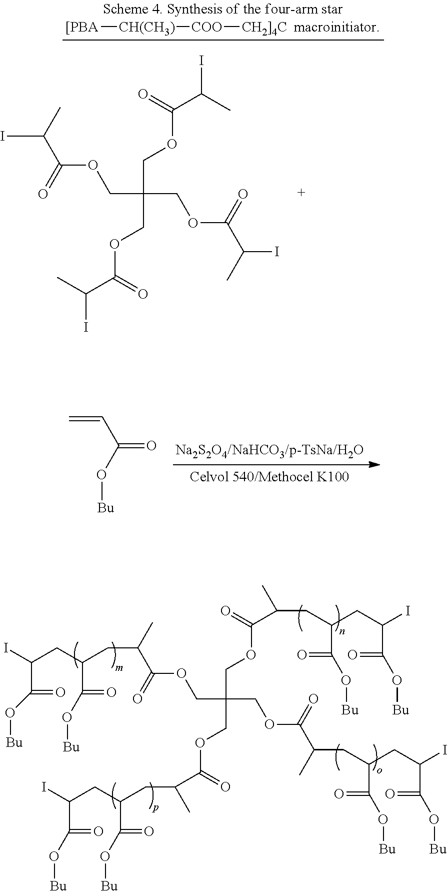

### Synthesis of the Four-Arm Star-Block Copolymer [PVC-b-PBA-CH(CH₃)—CO—O—CH₂]₄C

The [PBA-CH(CH₃)—CO—O—CH₂]₄C synthesized as shown in Scheme 4 was used as a macroinitiator (PBA-4IPr) for the synthesis of the [PVC-b-PBA-CH(CH₃)—CO—O—CH₂]₄C four-arm starblock copolymer. The synthesis of this block copolymer is illustrated in Scheme 5. Three experiments were performed.

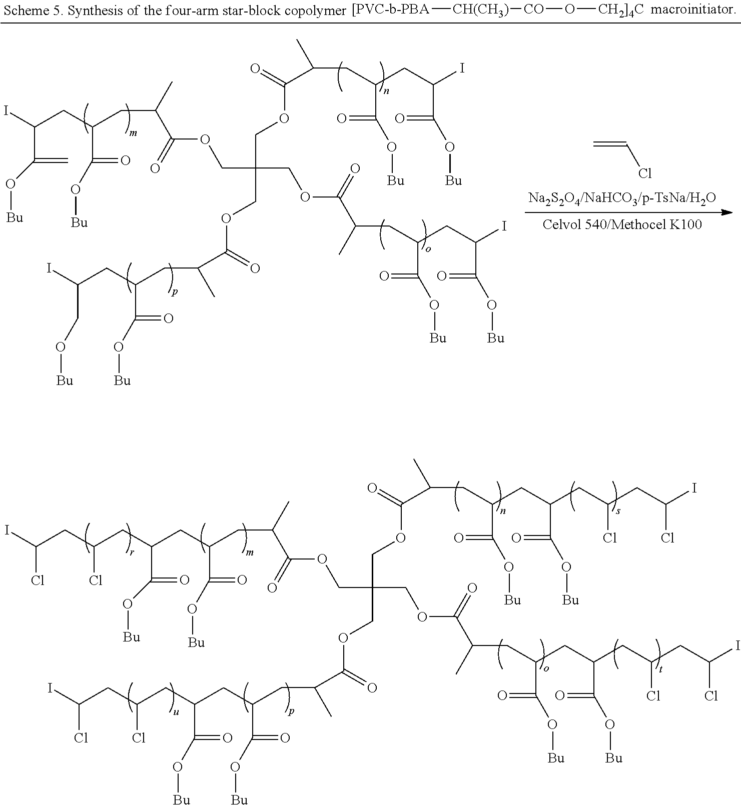

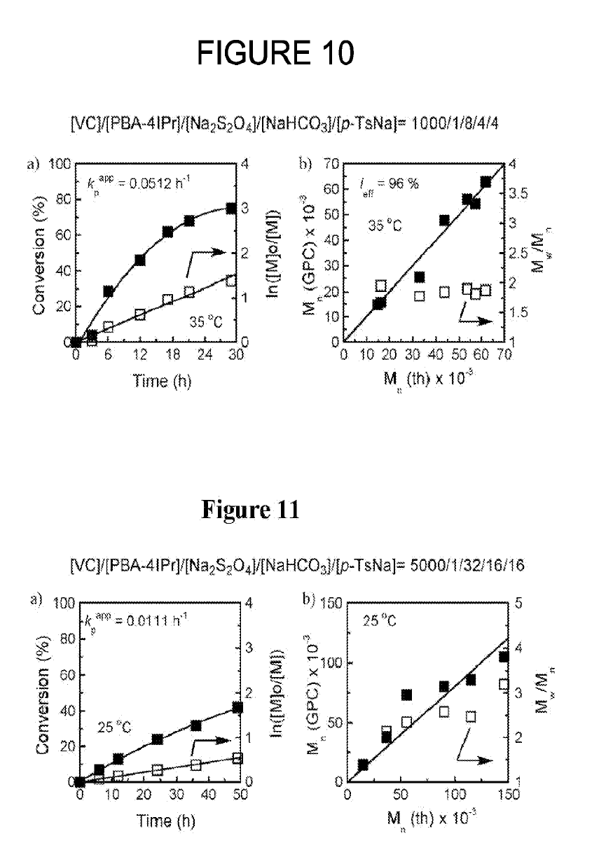

In the first experiment the initial ratio [VC]₀/[PBA-4IPr]₀ was 1,000 while in the second experiment this ratio was 5,000. Kinetic experiments of the block copolymerization were carried out in both cases (FIGS. 10 and 11). The block copolymerization with the initial ratio between VC and macroinitiator of 1,000 was carried out at 35° C. (FIG. 10) while the one with the ratio of 5,000 was performed at 25° C. In the block copolymerization from FIG. 10, a conversion of VC of about 70% was obtained in 30 h at 35° C. The block copolymerization shows a first order in the concentration of macroinitiator and of VC. This trend demonstrates s living block copolymerization of VC initiated from the PBA macroinitiator (FIG. 10a). The molecular weight distribution of the resulting four-arm star block copolymer is similar to that of the four-arm star macroinitiator (FIG. 10b).

The kinetic of the second block-copolymerization experiment was performed at 25° C. and is shown in FIG. 11. The lower polymerization temperature provides a lower rate of block-copolymerization. Only about 40% conversion was obtained in 50 h (FIG. 11a). However, this kinetic also shows a first order of the polymerization in growing species and in VC. As in the previous kinetic (FIG. 10) the current experiment shows a linear dependence of Mₙ^{GPC} on conversion and on Mₙ^{th}. An approximately constant M_{w}/Mₙ value of the resulting block copolymer was observed regardless of conversion. The first two experiments are also summarized in Tables 1 and 2.

TABLE 1
The Kinetic Data for the Synthesis of Four-Arm Star-Block Copolymer
[PVC-b-PBA-CH(CH₃)—CO—O—CH₂]₄C Under the Following Conditions:
[VC]₀/[PBA-4IPr]₀/[Na₂S₂O₄]₀/[NaHCO₃]₀/[p-TsNa]₀ = 1000/1/8/4/4

| | | | | | Mₙ^{GPC} | |
|---|---|---|---|---|---|---|
| | Time | Conversion | | | PBA or | |
| Sample | [h] | [%] | Mₙ^{th} | Mₙ^{GPC} | PVC/arm | M_{w}/Mₙ |
| Four-Arm Star | 0 | 0 | — | 14,864 | 3,627 | 1.642 |
| [PBA-CH(CH₃)—CO—O—CH₂]₄C | | | | | | |
| Four-Arm Star | 2 | 2 | 16,114 | 15,766 | 353 | 1.960 |
| [PVC-b-PBA-CH(CH₃)—CO—O—CH₂]₄C | 6 | 29 | 32,989 | 25,518 | 2,791 | 1.784 |
| | 12 | 46 | 43,614 | 47,875 | 8,380 | 1.853 |
| | 17 | 62 | 53,614 | 56,100 | 10,436 | 1.903 |
| | 21 | 68 | 57,364 | 54,370 | 10,004 | 1.821 |
| | 29 | 75 | 61,739 | 62,917 | 12,140 | 1.880 |

TABLE 2
The Kinetic Data for Synthesis of Four-Arm Star-Block Copolymer
[PVC-b-PBA-CH(CH₃)—CO—O—CH₂]₄C Under the Following Conditions:
[VC]₀/[PBA-4IPr]₀/[Na₂S₂O₄]₀/[NaHCO₃]₀/[p-TsNa]₀ = 5000/1/32/16/16

| | | | | | Mₙ^{GPC} | |
|---|---|---|---|---|---|---|
| | Time | Conversion | | | PBA or | |
| Sample | [h] | [%] | Mₙ^{th} | Mₙ^{GPC} | PVC/arm | M_{w}/Mₙ |
| Four-Arm Star | 0 | 0 | — | 14,864 | 3,627 | 1.642 |
| [PBA-CH(CH₃)—CO—O—CH₂]₄C | | | | | | |
| Four-Arm Star | 6 | 7 | 36,739 | 38,021 | 5,916 | 2.139 |
| [PVC-b-PBA-CH(CH₃)—CO—O—CH₂]₄C | 12 | 13 | 54,489 | 73,442 | 14,772 | 2.352 |
| | 24 | 24 | 89,864 | 80,740 | 16,597 | 2.583 |
| | 36 | 32 | 114,864 | 86,123 | 17,942 | 2.470 |
| | 49 | 42 | 145,114 | 105,110 | 22,689 | 3.201 |

In the third experiment a ratio [VC]₀/[PBA-4IPr]₀ of 10,000 was used and only two data points were collected for the kinetic experiment. These data are reported in Table 3.

TABLE 3
The Kinetic Data for the Synthesis of Four-Arm Star-Block-Copolymer
[PVC-b-PBA-CH(CH₃)—CO—O—CH₂]₄C Under the Following Conditions:
[VC]₀/[PBA-4IPr]₀/[Na₂S₂O₄]₀/[NaHCO₃]₀/[p-TsNa]₀ = 10,000/1/64/32/32

| | | | | | Mₙ^{GPC} | |
|---|---|---|---|---|---|---|
| | Time | Conversion | | | PBA or | |
| Sample | [h] | [%] | Mₙ^{th} | Mₙ^{GPC} | PVC/arm | M_{w}/Mₙ |
| Four-Arm Star | 0 | 0 | — | 14,864 | 3,627 | 1.642 |
| [PBA-CH(CH₃)—CO—O—CH₂]₄C | | | | | | |
| Four-Arm Star | 24 | 10 | 76,675 | 82,112 | 16,939 | 2.918 |
| [PVC-b-PBA-CH(CH₃)—CO—O—CH₂]₄C | 20 | 54 | 351,675 | 148,844 | 33,622 | 2.627 |

### Structural Analysis of [PVC-b-PBA-CH(CH₃)—CO—O—CH₂]₄C Four-Arm Star-Block Copolymer.

The structure of the four-arm star [PVC-b-PBA-CH(CH₃)—CO—O—CH₂]₄C obtained by SETDTLRP of VC initiated with the four-arm star [PBA-C(CH₃)—CO—O—CH₂]₄C macroinitiator was elucidated by ¹H NMR spectroscopy. Two samples of the four-arm star [PVC-b-PBA-CH(CH₃)—CO—OCH₂]₄C obtained at 29% and 46% conversion were analyzed by NMR and their structure is shown in FIGS. 12b and c, respectively. For the comparison the NMR analysis of the [PBA-CH(CH₃)—CO—OCH₂]₄C macroinitiator is shown in FIG. 12a. The NMR spectra of four-arm star-block copolymers show four sets of strong resonances. The resonance at 0.94 ppm is related to ˜CH₃ group of PBA part of the block copolymer as well as of 4IPr initiator. The overlapped resonances in the range 1.37-2.55 ppm represent ˜CH₂˜ groups of both PBA and PVC part of the block copolymer and ˜CH—C(O)OC₄H₉. The multiples in the range of 2.55-2.69 represent CH₂ groups (˜CH₂CHClI) neighboring the chain ends. At 4.03 ppm the resonance corresponding to ˜C(O)O—CH₂— is observed. The characteristic signals related to ˜CHCl˜ are in the range of 4.30-4.81 ppm. These two strong signals overlap with ˜(CH₃)₄C and ˜CH—CH₃ of the initiator. The two signals at 5.92 ppm and 6.03 ppm are assigned to the two stereoisomers r and m of the ˜CHClI four identical chain ends. The structural defects of PVC are observed only at the noise level.

Tables 1, 2 and 3 summarize the structure of the four-arm star-block copolymers synthesized. As it can be observed from these tables the theoretical Mₙ of the four-arm star-block copolymer is always lower than the experimental value obtained by GPC calibrated with polystyrene standards. This result is expected since the hydrodynamic volume of a four-arm star-block copolymer is lower than that of the corresponding linear block copolymer. The Mₙ of PBA per arm in the four arm-star macroinitiator and four-arm star-block copolymer is 3,627. The Mₙ of the PVC segment per arm from the four-arm starblock copolymer varies between 353 and 33,622.

Pentaerythritol tetrakis(2-iodopropionate) was used as a tetrafunctional initiator for the Na₂S₂O₄ catalyzed SET-DTLRP of n-butyl acrylate in water at room temperature. The resulting tetrafunctional poly(n-butyl acrylate) macroinitiator with Mₙ=14,864 or Mₙ=3,627 per arm was used to initiate the SET-DTLRP of vinyl chloride and provide four-arm star-block copolymers [PVC-b-PBA-CH(CH₃)—CO—OCH₂]₄C. The Mₙ of the PVC segment from each arm of the four-arm star-block copolymer varied between 353 and 33,622. These experiments provide the first examples of thermoplastic elastomers based on four-arm star-block copolymers containing PBA as soft segment and PVC as hard segment.

What is claimed:

1. A process for the production of a multiarmed star copolymer comprising polymerizing vinyl chloride with a multifunctional initiator in the presence of Na₂S₂O₄ and water.

2. The process of claim 1, where the multifunctional initiator is a bifunctional or tetrafunctional initiator.

3. The process of claim 1, wherein the multifunctional initiator is 1,2-bis(iodopropionyloxy)ethane, dimethyl 2,5-diiodohexanedioate, bis(2-methoxyethyl)-2,5-diiodohexanedioate, pentaerythritol tetrakis(2-iodopropionate), or [PBA-CH(CH₃)—COO—CH₂]₄C where PBA is iodo terminated poly(n-butyl acrylate).

4. The process of claim 1, wherein the molar ratio of Na₂S₂O₄ to multifunctional initiator is 2:1 to 100:1.

5. The process of claim 1, wherein the molar ratio of vinyl chloride to multifunctional initiator is 500 to 10,000.

6. The process of claim 1, wherein said contacting is performed at a temperature of 20 to 60° C.

7. The process of claim 1, wherein each arm of said multiarmed star copolymer has a molecular weight (Mn) of 200 to 35,000.

8. The process of claim 1, wherein said multiarmed star copolymer comprises [PVC-b-PBA-CH(CH₃)—COO—CH₂]₄C where PVC is polyvinyl chloride and PBA is poly(n-butyl acrylate).

9. A compound of the formula [PBA-CH(CH₃)—COO—CH₂]₄C where PBA is iodo terminated poly(n-butyl acrylate).

10. A compound of the formula [PVC-b-PBA-CH(CH₃)—COO—CH₂]₄C where PVC is polyvinyl chloride and PBA is poly(n-butyl acrylate).

11. An article containing a polymer produced by the process of claim 1.

12. The article of claim 11, wherein said article is substantially free of plasticizer.

13. The article of claim 12, wherein said article is substantially free of phthalates.

14. A multiarmed star copolymer comprising polyvinyl chloride.

15. The multiarmed star copolymer of claim 14, wherein each arm of said multiarmed star copolymer has a molecular weight (Mn) of 200 to 35,000.

16. A process for making an article comprising polyvinyl chloride comprising forming said article from a multiarmed star copolymer comprising polyvinyl chloride made by the process of claim 1, said performing occurring substantially in the absence of a plasticizer.

17. The process of claim 16, wherein said multiarmed star copolymer comprising polymerizing vinyl chloride with a multifunctional initiator in the presence of Na₂S₂O₄ and water.

18. The process of claim 16, wherein said multifunctional initiator is 1,2-bis(iodopropionyloxy)ethane, dimethyl 2,5-diiodohexanedioate, bis(2-methoxyethyl)-2,5-diiodohexanedioate, pentaerythritol tetrakis(2-iodopropionate), or [PBA-CH(CH₃)—COO—CH₂]₄C where PBA is iodo terminated poly(n-butyl acrylate).

19. The process of claim 16, wherein the molar ratio of Na₂S₂O₄ to multifunctional initiator is 2:1 to 100:1, the molar ratio of vinyl chloride to multifunctional initiator is 500 to 10,000, and the contacting is performed at a temperature of 20 to 60° C.

20. The process of claim 16, wherein each arm of said multiarmed star copolymer has a molecular weight (Mn) of 200 to 35,000
